(19) United States
(12) Patent Application Publication
(10) Pub. No.: US 2021/0082012 A1
(43) Pub. Date: Mar. 18, 2021

(54) USER INTERFACE, SYSTEM AND METHOD FOR AUTOMATIC MATCHING OF PARTIES TO A TRANSACTION PROPOSAL

(71) Applicant: GOLLGI INTERNATIONAL LTD., London (GB)

(72) Inventor: Eitan KOREN, London (GB)

(21) Appl. No.: 17/060,266

(22) Filed: Oct. 1, 2020

Related U.S. Application Data
(63) Continuation-in-part of application No. 16/092,558, filed on Oct. 10, 2018, now abandoned.
(60) Provisional application No. 62/320,544, filed on Apr. 10, 2016.

(51) Int. Cl. G06Q 30/06; G06Q 30/08; G06Q 10/08; G06Q 20/08; G06F 16/9535; G06F 16/9538; G06F 40/205

(52) U.S. Cl. CPC G06Q 30/0605; G06Q 30/08; G06Q 30/0609; G06Q 10/087; G06Q 30/0611; G06F 40/205; G06Q 30/0627; G06Q 20/085; G06F 16/9535; G06F 16/9538; G06Q 30/0641

(57) ABSTRACT

The invention provides a system and method for automatic matching of initiator-responder to a transaction proposal, using natural language (NL). The initiator formulates a request for goods/services with their qualifiers he wishes to purchase and responders matching the request are proposed.

### CROSS REFERENCE TO RELATED APPLICATIONS

This patent application is a continuation-in-part (CIP) of U.S. Ser. No. 16/092,558 filed Oct. 10, 2018, which is a National Phase Application of PCT/IL2017/050437 published as WO2017179050 and filed Apr. 9, 2017, which claims priority to U.S. Provisional application No. 62/320,544 filed Apr. 10, 2016. The contents of the above referenced applications are incorporated herein in their entirety.

### FIELD OF THE INVENTION

The present invention generally related to a computer-implemented system and method for automatic matching of parties to a transaction proposal, and more particularly to a user interface, system and method for automatic matching of parties to a transaction proposal, using natural language (NL).

### BACKGROUND OF THE INVENTION

Natural language (NL) generally refers to the interaction of a user with a computerized system through inputs supplied by the user in a natural language (e.g. human structured syntax). It allows the user to type (or speak) a phrase specifying the requested information.

U.S. Pat. No. 8,775,322 B2 discloses a system for matching buyers and sellers based on buyers and sellers preferences. Prospective buyers can locate potential sellers based on buyer preferences and seller characteristics. Prospective sellers can locate potential buyers on seller preferences and characteristics.

US 2003/0004859 discloses a secure, computer-based method and system for anonymously and confidentially matching indications of interest from potential buyers and sellers.

### SUMMARY OF THE INVENTION

It is hence one object of the invention to disclose a computer implemented broker system for automatically matching at least one buyer party and at least one seller party. The aforesaid system comprises: (a) a processor; (b) a database of potential seller parties and qualifiers thereof; said database being fillable by said potential seller parties by posting therein; said potential seller party qualifiers being relevant to a potential offering; (c) a data repository comprising a plurality of sub-databases attributable to said potential seller parties in an individual manner; each of said sub-database storing a list of goods and services to be offered by said potential seller parties and qualifiers of said goods and services; (d) a memory storing instructions which, when executed by said processor, direct said processor to matching between said at least one buyer party and at least one seller party.

It is a core purpose of the invention to provide the memory further comprises instructions to: (a) display user interfaces provided to said buyer party and seller party; (b) receive a request for an offer from said buyer party, said request for said offer comprising a natural language description of goods or services for procurement and buyer party qualifiers; said natural language description comprising an element selected from the group consisting of a text description, a sound sample, a static or dynamic image and any combination thereof; (c) parse said text description into search keywords for identifying goods or services and qualifiers thereof relevant to said search keywords within said at least one of said sub-database of said data repository; (d) compile an offer list of said goods or services and qualifiers thereof matching said search keywords identified within at least one of said sub-database of said data repository; each entry of said offer list comprising a good or a service and qualifiers thereof matching said search keywords and said buyer party offered said good or service for sale and qualifiers thereof; (e) communicating said offer list to said buyer party such that said seller party qualifiers and qualifies of said good or service being masked from said buyer party; and (f) concurrently, when said buyer party opens said entry relating to said seller party, charging said seller party for a predetermined value, displaying said qualifiers of said good or service to said buyer party and displaying said qualifiers of said buyer and seller parties to each other.

Another object of the invention is to disclose a method for automatically matching one buyer party and at least one seller party. The aforesaid method comprises steps of: (a) providing a data repository comprising a plurality of sub-databases attributable to said potential seller parties in an individual manner; each of said sub-database storing a list of goods and services to be offered by said potential seller parties and qualifiers of said goods and services; (b) providing a database of potential seller parties and qualifiers thereof; said database being fillable by said potential seller parties by posting therein; said potential seller party qualifiers being relevant to a potential offering; (c) displaying user interfaces provided to said buyer party and seller party; (d) receiving a request for an offer from said buyer party, said request for said offer comprising a natural language description of goods or services for procurement and buyer party qualifiers; said natural language description comprising an element selected from the group consisting of a text description, a sound sample, a static or dynamic image and any combination thereof; (e) parsing said text description into search keywords for identifying goods or services and qualifiers thereof relevant to said search keywords within said at least one of said sub-database of said data repository; (f) compiling an offer list of said goods or services and qualifiers thereof matching said search keywords identified within at least one of said sub-database of said data repository; each entry of said offer list comprising a good or a service and qualifiers thereof matching said search keywords and said buyer party offered said good or service for sale and qualifiers thereof; (g) communicating said offer list to said buyer party such that said seller party qualifiers and qualifies of said good or service being masked from said buyer party; and (h) concurrently, when said buyer party opens said entry relating to said seller party, charging said seller party for a predetermined value, displaying said qualifiers of said good or service to said buyer party and displaying said qualifiers of said buyer and seller parties to each other.

A further object of the invention is to disclose a non-transitory computer-readable medium with instructions stored thereon, that when executed by a processor, performs the steps comprising: (a) displaying user interfaces provided to said buyer party and seller party; (b) receiving a request for an offer from said buyer party, said request for said offer comprising a natural language description of goods or services for procurement and buyer party qualifiers; said natural language description comprising an element selected from the group consisting of a text description, a sound sample, a static or dynamic image and any combination thereof; (c) parsing said text description into search keywords for identifying goods or services and qualifiers thereof relevant to said search keywords within said at least one of said sub-database of said data repository; (d) compiling an offer list of said goods or services and qualifiers thereof matching said search keywords identified within at least one of said sub-database of said data repository; each entry of said offer list comprising a good or a service and qualifiers thereof matching said search keywords and said buyer party offered said good or service for sale and qualifiers thereof; (e) communicating said offer list to said buyer party such that said seller party qualifiers and qualifies of said good or service being masked from said buyer party; and (f) concurrently, when said buyer party opens said entry relating to said seller party, charging said seller party for a predetermined value, displaying said qualifiers of said good or service to said buyer party and displaying said qualifiers of said buyer and seller parties to each other.

### BRIEF DESCRIPTION OF THE DRAWINGS

FIG. 1a provides a functional block diagram for an automatic matching of parties to a transaction proposal system;

FIG. 1b provides an exemplary flowchart of a method of automatically matching one buyer party and at least one seller party;

FIG. 2 illustrates a flow of information, related to the transaction mediation module;

FIG. 3 illustrates a flow of information, related to the different sub-modules of the transaction mediation module;

FIG. 4 is a flowchart for a routine generally illustrative of steps carried out in accordance with some embodiments to match seller parties to a transaction proposal, responsive to a natural language input by a buyer; and

FIGS. 5-17 are screen shots in accordance with some embodiments of the user interface of the present invention.

### DETAILED DESCRIPTION OF THE PREFERRED EMBODIMENTS

The following is a detailed description of the preferred embodiments. Reference is made to the accompanying drawings that form a part hereof, and in which are shown by way of illustration, specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Although the technology will be described in conjunction with various embodiment(s), it will be understood that they are not intended to limit the present technology to these embodiments. To the contrary, the present technology is intended to cover alternatives, modifications and equivalents which may be included within the spirit and scope of the various embodiments as defined by the appended claims.

In the following description of embodiments, numerous specific details are set forth in order to provide a thorough understanding of the present technology. However, the present technology may be practiced without these specific details. In other instances, well known methods, procedures, components, and circuits have not been described in detail so as not to unnecessarily obscure aspects of the present embodiments.

The term “qualifier of seller” refers to any seller additional information related to him (e.g. name, location) and to his goods/services (e.g. time to production, availability, price, payment conditions).

The term “qualifier of goods/services” refers to any goods/service additional details related to the buyer party request (e.g. brand, model, size, color, and price) The invention provides a system and method for automatic matching of buyer-seller party to a transaction proposal, using natural language (NL). A buyer party formulates a request for goods/services with their qualifiers he wishes to purchase and seller parties matching the request are proposed.

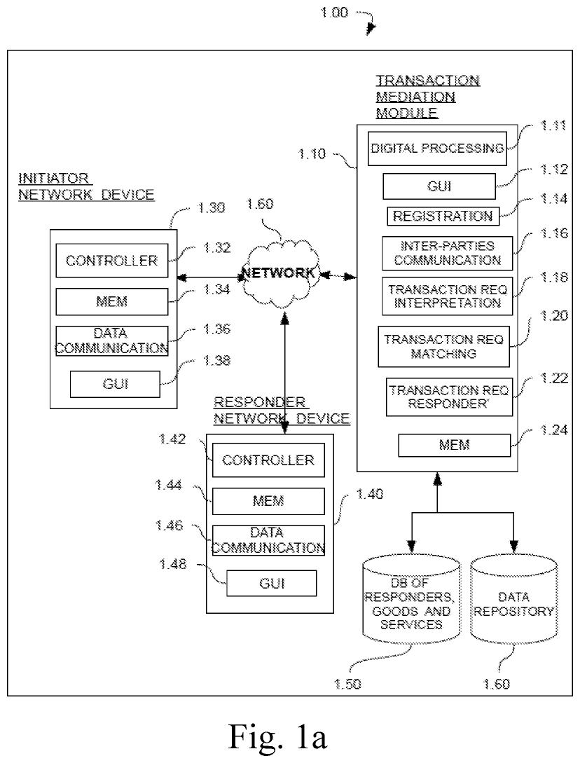

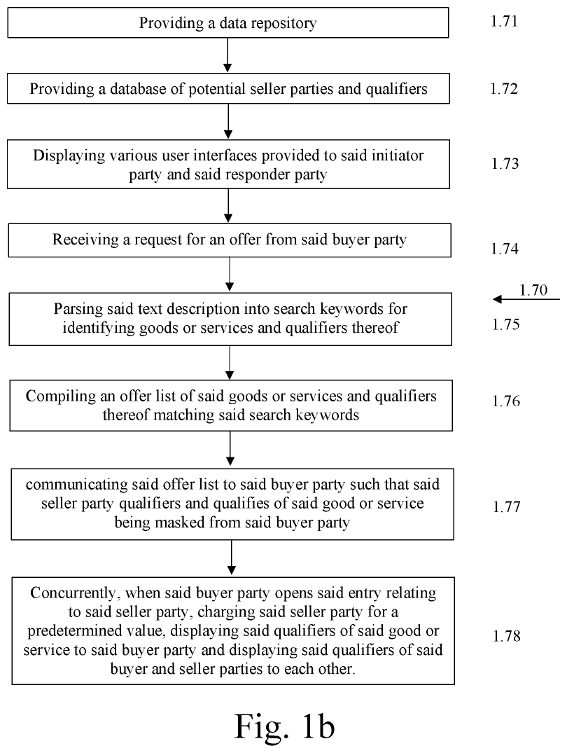

Reference is now made to FIG. 1a depicting an automatic matching of parties to a transaction proposal system 1.0 in accordance with some embodiments. The system includes a number of components including one or more transaction mediation modules 1.10, a buyer network device 1.20, a seller network device 1.30 and two databases: a database of the seller parties, their products and services 1.40 and a data repository 1.50. The buyer device, seller device and the transaction mediation module(s) communicate over a network 1.60, such as a wide area network, a local area network, a broadband wireless, etc.

The buyer network device is shown to include a controller 1.32, local memory (MEM) 1.34, a data communication means 1.36 and a graphical user interface (GUI) 1.38. The controller may be hardware based or programmable processor which includes top level control of the device responsive to input supplied by the buyer party via the GUI. The device memory stores information input by the buyer, programming and control information utilized by the controller and information transferred to the device over the network. The GUI may include a keyboard, keypad, mouse, monitor, touch screen, touch pad and any other suitable component to enable human comprehensive interaction with and/or control of the device.

The seller network device is shown to include a controller 1.42, local memory (MEM) 1.44, a data communication means 1.46 and a graphical user interface (GUI) 1.48. The controller may be hardware based or programmable processor which includes top level control of the device responsive to input supplied by the seller party via the GUI. The device memory stores information input by the seller party, programming and control information utilized by the controller and information transferred to the device over the network. The GUI may include a keyboard, keypad, mouse, monitor, touch screen, touch pad and any other suitable component to enable human comprehensive interaction with and/or control of the device.

Both devices can take a variety of forms, including but not limited to a desktop computer, a laptop computer, a tablet, a smart phone or some other suitable network accessible platforms.

The transaction mediation module can similarly take a variety of forms, and is shown in FIG. 1a to include a digital processing unit 1.11, a graphical user interface 1.12, a registration module 1.14, an inter-party communication means 1.16, a transaction request interpretation 1.18, a transaction request matching 1.20, a transaction request seller 1.22 and local memory (MEM) 1.24. While only a single buyer, a single seller party and a single transaction mediation module are shown in FIG. 1, it will be appreciated that any number of respective devices and modules can be interconnected and utilized in accordance with the present disclosure.

The data base of seller parties, products and services 1.50 includes for each seller party, the seller qualifiers and a list of services/goods he offers.

The data repository 1.60 is a knowledge base including definitions of goods/services and associated structured data including qualifiers of said goods.

As explained below, a buyer party of the buyer device can access the transaction mediation module to generate a request in a natural language.

Reference is now made to FIG. 1b presenting an exemplary flowchart of method 1.70 of automatically matching one buyer party and at least one seller party. Method 1.70 starts at steps of providing a data repository 1.71 containing of definitions of goods and services and their qualifiers and providing an open database of potential sellers and potential seller qualifiers 1.72. According to one embodiment of the present invention, the data repository can be segmentized such that goods and services and their qualifiers offered for sale by each seller are arranged into separated sub-databases (on-line shops). The open database is fillable by said potential sellers by registration therein. User interfaces are displayed to the buyer party and seller party at step 1.73. Numeral 1.74 refers to receiving a request for an offer from the buyer party. The aforesaid request for an offer includes a description comprising an element selected from the group consisting of a natural language description, a sound sample, a static or dynamic image and any combination thereof. The request for an offer is parsed into search keywords at step 1.75. On the basis of obtained search keywords, a request provision list computed to match to the transaction request of the buyer party is compiled at step 1.76. Composing and communicating a transaction request reply to the buyer party is performed (step 1.77). Finally, at step 1.88, when the buyer party opens said entry relating to said seller party, the seller party is charged for a predetermined value, displaying said qualifiers of said good or service to said buyer party and the qualifiers of the buyer and seller parties are displayed to each other.

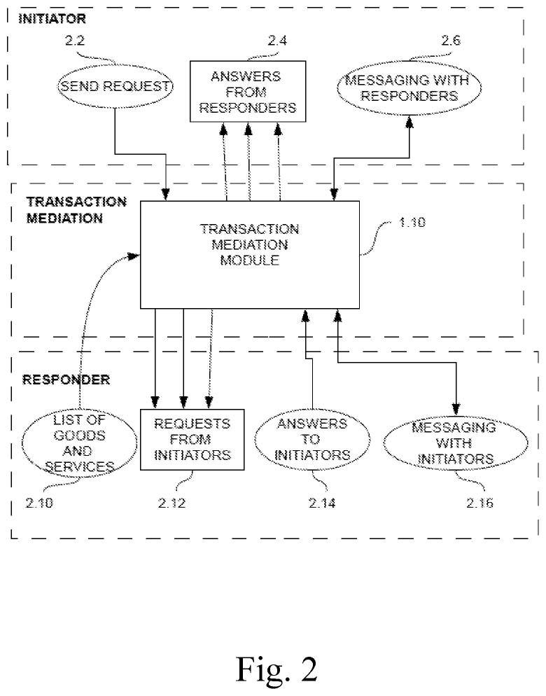

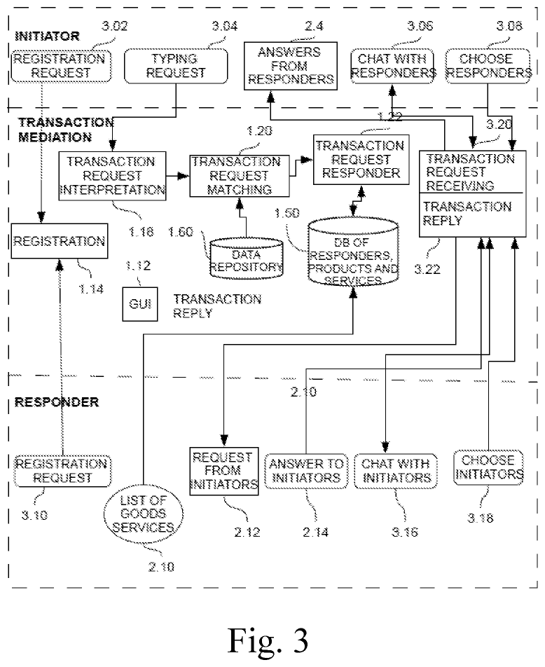

Reference is now made to FIG. 2 illustrating the flow of information, relating to the transaction mediation module 1.10 that can be incorporated into the system 1.0 of FIG. 1a. As per step 2.2, once the buyer party is registered (not shown in the figure), the buyer party may send a request for a good/service in a natural language, the transaction mediation module is processing the request (see more details below) and after finding appropriate seller parties and negotiating between seller and buyer parties (2.6, 2.16), it sends the buyer party request 2.12 to them and forwards the answers of the seller parties to the buyer party (answers from sellers 2.4). Reference is now made to FIG. 3 illustrating the flow of information and relating to the different components of transaction mediation module 1.10, which may be incorporated into the system 1.0 of FIG. 1a.

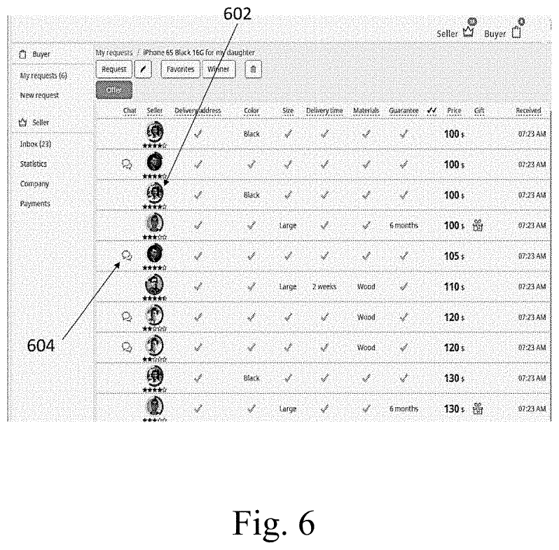

As per step 3.02 and step 3.10, both the buyer party and the seller register to the system. A seller party is authorized for register only after checking his details e.g. reviews, bank account, method of payment) and a reliability wheel is then created (see below details on FIG. 6). Once the buyer party is registered, the buyer party may send a request for a good/service in a natural language as per step 3.04, the transaction request receiving component 3.20 is receiving it and forwarding it to the transaction request interpretation 1.18 which parses the transaction request into transaction keywords using a set of algorithms for processing the buyer party request, removing irrelevant words and forwards the result to the transaction request matching 1.20. The transaction request matching is then compiling a request provision list, including the matching goods/services appropriate to the buyer party request. The list is then forwarded to the transaction request seller 1.22, which compiles a list of potential seller parties being capable of providing the matching goods/services. An inter-communication process between seller parties and buyers occurs through the inter-party communication component using which may include chat with seller parties 3.06, chat with buyer parties 3.16. Once there is an agreement between the buyer party and seller party, transaction reply component 3.22 communicates the reply (answers from seller parties 2.14) to the buyer party.

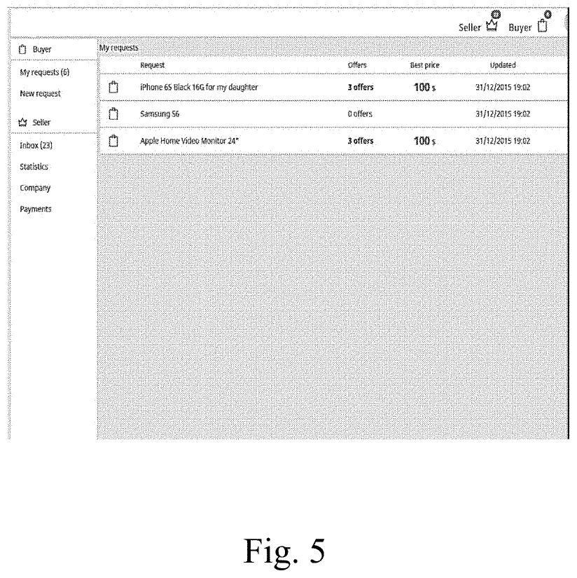

The transaction meditation system provides the interactive link between the buyers and the seller parties, and display the various user interfaces (GUI 1.12) of the present invention. More details about the various user interfaces are mentioned below (see FIGS. 5-18 details below).

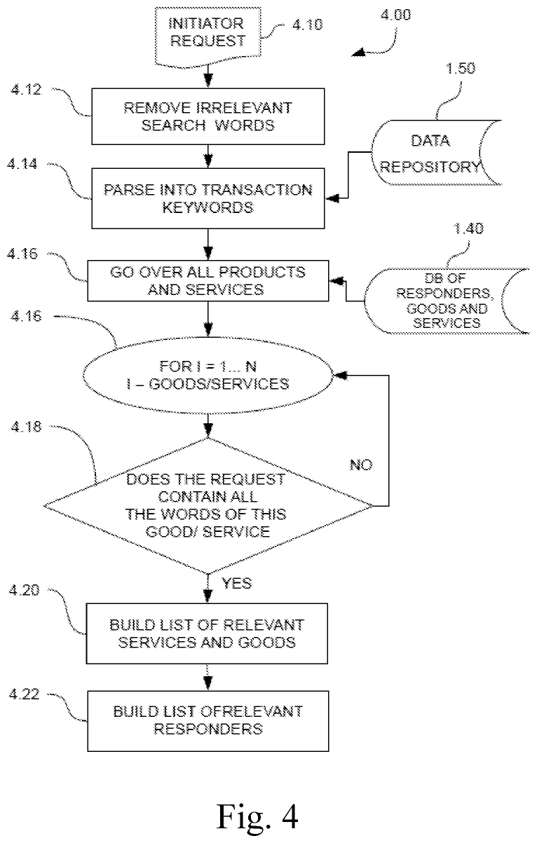

Reference is now made to FIG. 4 showing a sequence of the transaction meditation algorithm processed by the transaction mediation module of FIG. 1a.

Upon any buyer party request, the transaction mediation algorithm is initiated. The buyer party request is processed with algorithms that extract the meaning of the request and identify the good/services that the buyer party has demanded.

First irrelevant search words are removed as per step 4.12 and the request is parsed into transaction keywords as per step 4.14, with the help of the data repository 1.50. Next a search is performed to find the appropriate goods/services as per step 4.16 matching the buyer party request, a list of relevant goods/services with matching qualifiers is built as per step 4.20 and then the list of relevant seller parties who offer such good/services with appropriate qualifiers is built, with the help of the database of seller parties, products and services 1.40.

Reference is now made to FIGS. 5-18, illustrating screen shots of the present invention.

In this example, the buyer party is a buyer and the seller parties are sellers.

The screen shot displayed at FIG. 5 is initiated by a buyer which is willing to look at his requests. Each request appears with the number of offers, and the best price.

When the buyer is selecting “offers”, the GUI will display for each seller that enters an offer, the details of the offer, in that case, related to “IPhone 6S Back 16G for my daughter”, as displayed at FIG. 6. Each seller is marked with a reliability blue wheel 602 associated to the reliability of the seller. The green icon 604 signifies that a chat occurred between the seller and the buyer. There is a limit on the number of offers—the system is limited to 30 offers—the purpose is not to overload the buyer with too much information.

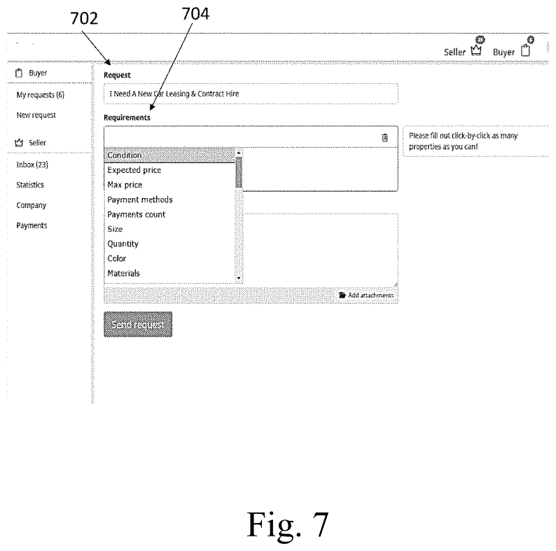

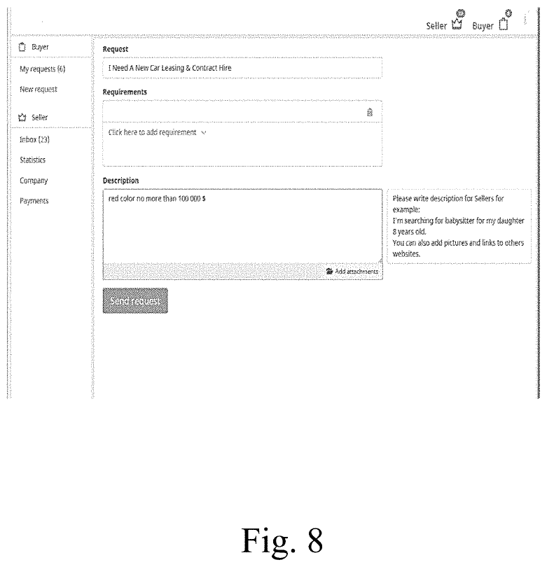

FIG. 7-FIG. 8 represent screen shot appearing in case the buyer inserts a new request 702 in natural language. FIG. 7 illustrates the new request and additional details associated to this new request. FIG. 8 illustrates a description of the new request added by the buyer.

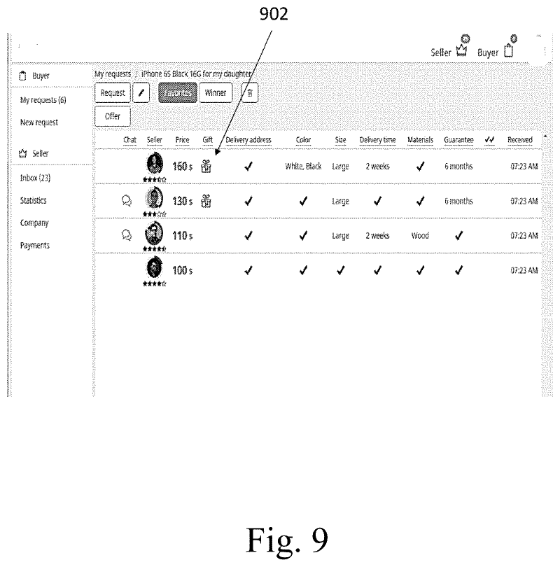

FIG. 9 illustrates a screen shot in case the buyer is willing to take a look on his favorites associated to his previous requests—some of the sellers offer a gift as part of the deal 902.

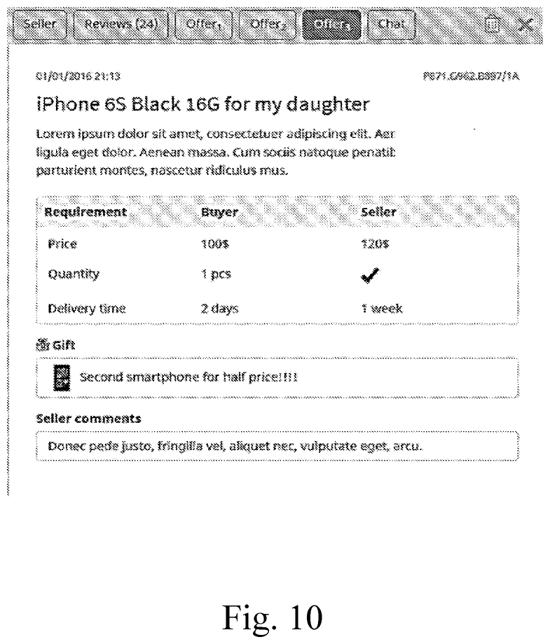

FIG. 10 illustrates a screen shot associated with the third offer that the buyer receives for “IPhone 6S Black 16G for my daughter” with details of the deal from the seller.

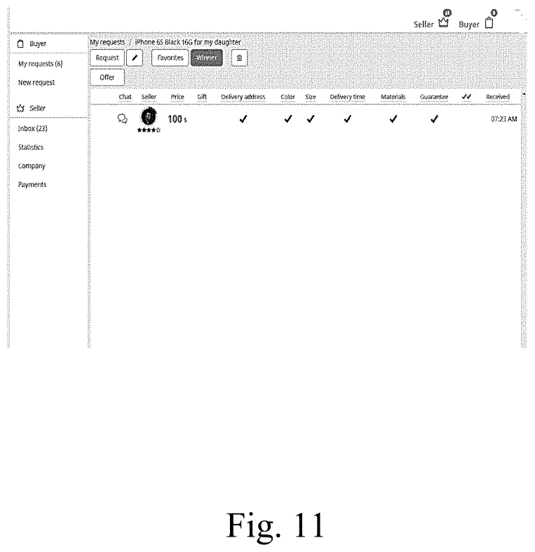

FIG. 11 illustrates a screen shot associated with the winner associated to the buyer's request for “IPhone 6S Black 16G for my daughter”.

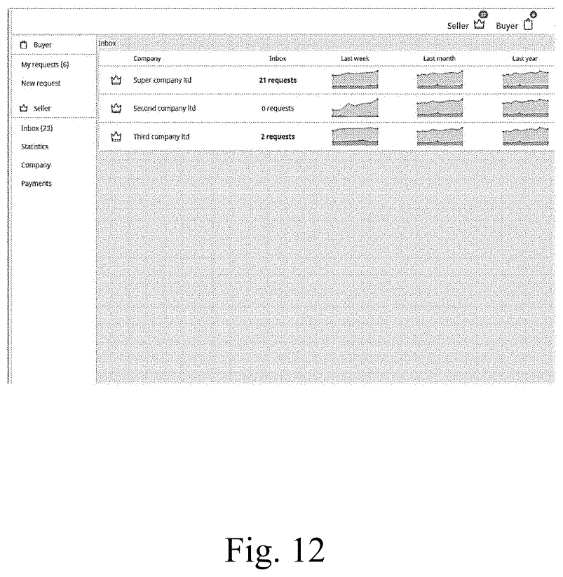

FIG. 12 illustrates a screen shot showing how many requests to which company happen.

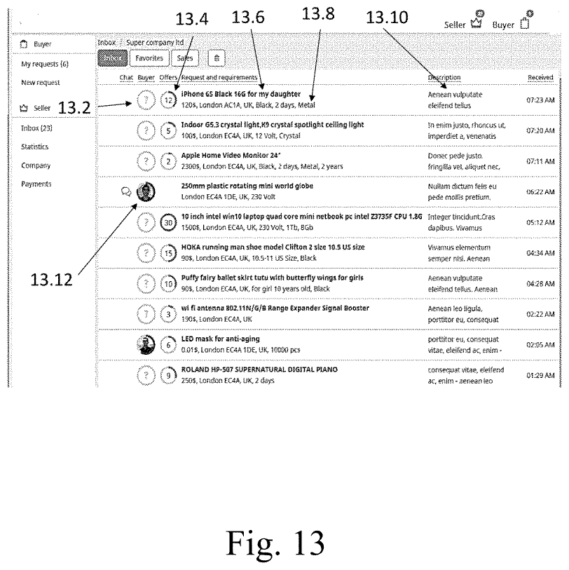

FIG. 13 illustrates a screen shot representing for each buyer, how many offers for each of his requests, e.g. first buyer 13.2 requests for “IPhone 6S Black 16G for my daughter”, gets 12 offers 13.4, with description 13.8.

A buyer also is associated with a reliability wheel 13.12. The reliability wheel associated to a buyer party is based on a number of criteria such as the number of times he really accepts seller offers, how many times the buyer party clicks to get an offer and didn't accept any offer.

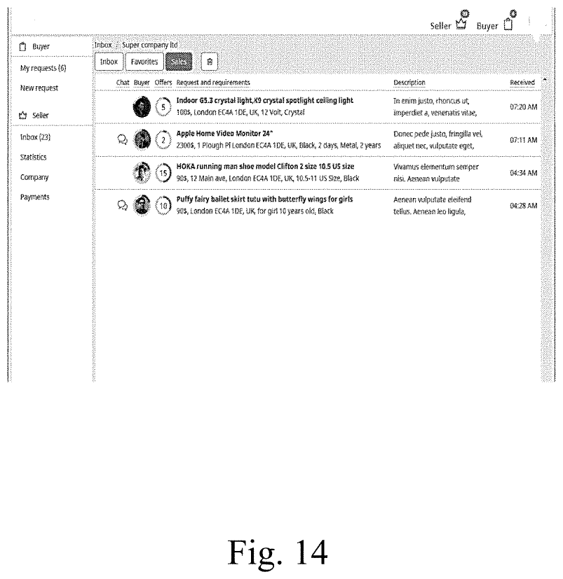

FIG. 14 illustrates a screen shot associated with companies and some details about these companies.

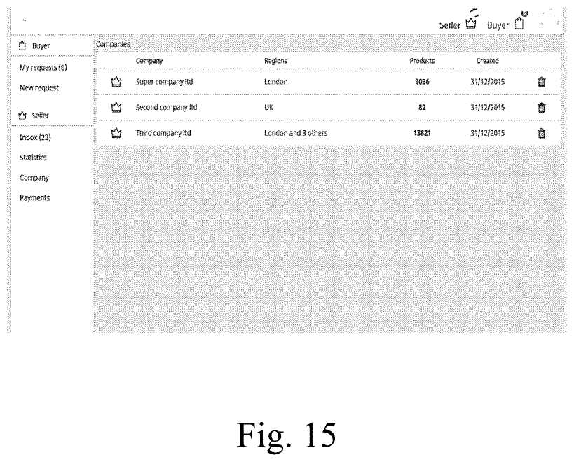

FIG. 15 illustrates a screen shot associated with the sales for one of companies presented at FIG. 14 “Super Company LTD”.

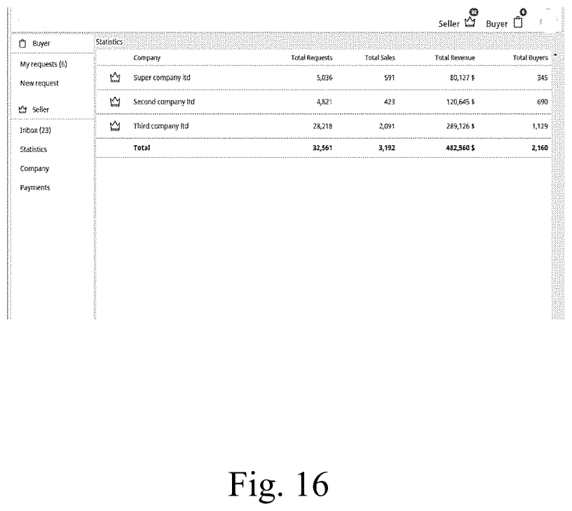

FIG. 16 illustrates a screen shot associated with the statistics for each these companies.

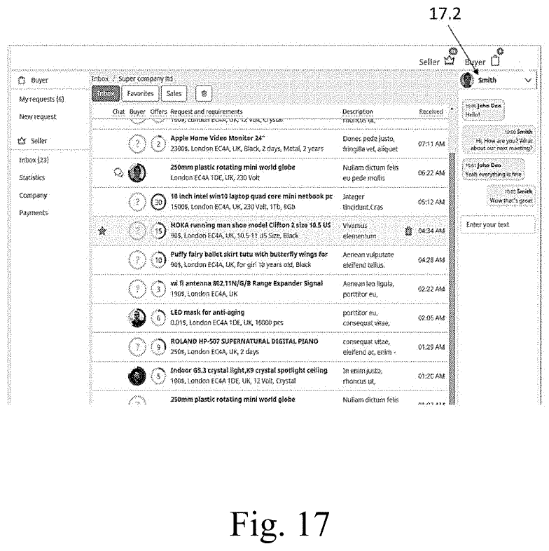

FIG. 17 illustrates a screen shot displaying a chat example between seller/buyer 17.02.

1. A computer implemented broker system for automatically matching at least one buyer party and at least one seller party; said system comprising:
a. a processor;
b. a database of potential seller parties and qualifiers thereof; said database being fillable by said potential seller parties by posting therein; said potential seller party qualifiers being relevant to a potential offering;
c. a data repository comprising a plurality of sub-databases attributable to said potential seller parties in an individual manner; each of said sub-database storing a list of goods and services to be offered by said potential seller parties and qualifiers of said goods and services;
d. a memory storing instructions which, when executed by said processor, direct said processor to matching between said at least one buyer party and at least one seller party;
wherein said memory further comprises instructions to:
i. display user interfaces provided to said buyer party and seller party;
ii. receive a request for an offer from said buyer party, said request for said offer comprising a natural language description of goods or services for procurement and buyer party qualifiers; said natural language description comprising an element selected from the group consisting of a text description, a sound sample, a static or dynamic image and any combination thereof;
iii. parse said text description into search keywords for identifying goods or services and qualifiers thereof relevant to said search keywords within said at least one of said sub-database of said data repository;
iv. compile an offer list of said goods or services and qualifiers thereof matching said search keywords identified within at least one of said sub-database of said data repository; each entry of said offer list comprising a good or a service and qualifiers thereof matching said search keywords and said buyer party offered said good or service for sale and qualifiers thereof;
v. communicating said offer list to said buyer party such that said seller party qualifiers and qualifies of said good or service being masked from said buyer party; and
vi. concurrently, when said buyer party opens said entry relating to said seller party, charging said seller party for a predetermined value, displaying said qualifiers of said good or service to said buyer party and displaying said qualifiers of said buyer and seller parties to each other.

2. A method for automatically matching one buyer party and at least one seller party; said method comprising steps of:
a. providing a data repository comprising a plurality of sub-databases attributable to said potential seller parties in an individual manner; each of said sub-database storing a list of goods and services to be offered by said potential seller parties and qualifiers of said goods and services;
b. providing a database of potential seller parties and qualifiers thereof; said database being fillable by said potential seller parties by posting therein; said potential seller party qualifiers being relevant to a potential offering;
c. displaying user interfaces provided to said buyer party and seller party;
d. receiving a request for an offer from said buyer party, said request for said offer comprising a natural language description of goods or services for procurement and buyer party qualifiers; said natural language description comprising an element selected from the group consisting of a text description, a sound sample, a static or dynamic image and any combination thereof;
e. parsing said text description into search keywords for identifying goods or services and qualifiers thereof relevant to said search keywords within said at least one of said sub-database of said data repository;
f. compiling an offer list of said goods or services and qualifiers thereof matching said search keywords identified within at least one of said sub-database of said data repository; each entry of said offer list comprising a good or a service and qualifiers thereof matching said search keywords and said buyer party offered said good or service for sale and qualifiers thereof;
g. communicating said offer list to said buyer party such that said seller party qualifiers and qualifies of said good or service being masked from said buyer party; and
h. concurrently, when said buyer party opens said entry relating to said seller party, charging said seller party for a predetermined value, displaying said qualifiers of said good or service to said buyer party and displaying said qualifiers of said buyer and seller parties to each other.

3. A non-transitory computer-readable medium with instructions stored thereon, that when executed by a processor, performs the steps comprising:
a. displaying user interfaces provided to said buyer party and seller party;
b. receiving a request for an offer from said buyer party, said request for said offer comprising a natural language description of goods or services for procurement and buyer party qualifiers; said natural language description comprising an element selected from the group consisting of a text description, a sound sample, a static or dynamic image and any combination thereof;
c. parsing said text description into search keywords for identifying goods or services and qualifiers thereof relevant to said search keywords within said at least one of said sub-database of said data repository;
d. compiling an offer list of said goods or services and qualifiers thereof matching said search keywords identified within at least one of said sub-database of said data repository; each entry of said offer list comprising a good or a service and qualifiers thereof matching said search keywords and said buyer party offered said good or service for sale and qualifiers thereof;
e. communicating said offer list to said buyer party such that said seller party qualifiers and qualifies of said good or service being masked from said buyer party; and
f. concurrently, when said buyer party opens said entry relating to said seller party, charging said seller party for a predetermined value, displaying said qualifiers of said good or service to said buyer party and displaying said qualifiers of said buyer and seller parties to each other.
